(19) United States
(12) Patent Application Publication
(10) Pub. No.: US 2011/0206364 A1
(43) Pub. Date: Aug. 25, 2011

(54) CAMERA SHUTTER DEVICE AND OPTICAL APPARATUS HAVING THE SAME

(75) Inventors: Jinsuk Han, Seoul (KR); Seungki Kim, Seoul (KR); Taehwan Kim, Seoul (KR)

(73) Assignee: LG Innotek Co., Ltd., Seoul (KR)

(21) Appl. No.: 13/031,870

(22) Filed: Feb. 22, 2011

(30) Foreign Application Priority Data
Feb. 22, 2010 (KR) 10-2010-0015813

(51) Int. Cl. G03B 9/14

(52) U.S. Cl. 396/463

(57) ABSTRACT

A camera shutter device and an optical apparatus having the same are disclosed. The shutter device includes a core wrapped by a coil, wherein a first distal end and a second distal end of the core are arranged in parallel, and when a voltage is applied to the coil, the first and second distal ends exhibit a mutually opposite polarity with respect to each other. A magnet is arranged with a side facing the first and second distal ends of the core for linearly and reciprocally moving between the first and second distal ends. In addition, a slider opens and closes a shutter blade as the magnet linearly and reciprocally moves. Thus, the driving unit of the core, magnet, and slider can be miniaturized and thinned, and a reciprocatively moving distance of a magnet can he minimally shortened to quicken the opening/shutting operation.

### CROSS-REFERENCE TO RELATED APPLICATION

This application claims the benefit under 35 U.S.C. §119 of Korean Patent Application No. 10-2010-0015813, filed Feb. 22, 2010, which is hereby incorporated by reference in its entirety.

### BACKGROUND OF THE DISCLOSURE

1. Technical Field

The teachings in accordance with the exemplary embodiments of this disclosure relate generally to a camera shutter device opening and shutting a lens nozzle in an optical imaging device including a camera-embedded mobile device, and an optical apparatus having the same.

2. Background Art

Recently, as the number of pixels in a camera-embedded mobile device increases, an optical imaging device including the camera-embedded mobile device is becoming diversified and high-graded (e.g., capable of photographing high quality pictures). Therefore, the camera-embedded mobile device is in need of adoption of a shutter configured to open and shut a lens nozzle such as that usually found in a general camera.

If such a shutter is employed in the camera-embedded mobile device, it may be possible to photograph an image of higher quality as compared to a camera-embedded mobile device deprived of a shutter, and a ground can be provided to enable an embedded camera to exhibit a performance of high resolution in a proper manner.

However, due to the fact that a small mobile device is restricted by installation space and battery consumption, miniaturization of the shutter device including a shutter and other elements used for operating the shutter, and reduction of driving power must be taken into consideration as a top priority.

That is, because the conventional shutter device has a disadvantageously large number of elements with a complicated operation structure, a large area of installation space is unnecessarily used, and power transmission loss increases to increase the battery consumption.

Another disadvantage is that a plurality of gears is used in the general camera shutter device and the picture quality of a captured image can be degraded due to a slow response speed of a shutter if a complicated link mechanism is employed. Accordingly, the shutter device should have a high shutter speed capable of instantly opening and shutting light reflected from an object.

### BRIEF SUMMARY

An object of the present disclosure is to solve at least one or more of the above disadvantages and/or shortcomings in a whole or in part and to provide at least one of the advantages described hereinafter.

Therefore, the present disclosure provides a camera shutter device capable of being miniaturized, of light weight, and thin.

The present disclosure also provides a camera shutter device capable of improving performance of a camera by increasing an opening/shutting speed of shutter blade.

The present disclosure also provides an optical apparatus configured for compactness by miniaturizing and thinning a camera shutter device therein.

Technical disadvantages and/or shortcomings to be solved by the present disclosure are not restricted to the above-mentioned, and any other technical problems not mentioned so far will be clearly appreciated from the following description by skilled in the art.

In one general aspect of the present disclosure, there is provided a camera shutter device, the device comprising: a core wrapped by a coil wherein a first distal end of the core and a second distal end of the core arc arranged in parallel at a same end of the core, and when a voltage is applied to the coil, each of the two distal ends exhibits a mutually opposite polarity; a magnet having a lateral side facing the two distal ends, the magnet arranged for linearly and reciprocally moving between the first and second distal ends; and a slider for opening/shutting a shutter blade as the magnet linearly and reciprocally moves.

According to an embodiment, the core includes a fixture fixed at a base; a first rod extended from the fixture, wrapped by a coil, and generating a first electromagnetic force line, where the first rod provides the first distal end; and a second rod extended from the fixture, arranged in parallel with the first rod, and generating a second electromagnetic force line, where the second rod provides the second distal end.

In one embodiment, the core constitutes a pair of cores with the magnet between the pair of cores, each core of the pair of cores having an end facing a lateral surface of the magnet and extending at a predetermined angle from the magnet.

In a further embodiment, each core of the pair of cores is wrapped with a corresponding coil of a pair of coils and the pair of coils is applied with a mutually opposite direction of voltage.

In accordance with certain embodiments of the invention, the first and second distal ends of the core are aligned at an angle to face a lateral surface of the magnet.

According to one embodiment, the first rod having the first distal end is shorter than the second rod having the second distal end.

According to another embodiment, the core constitutes a pair of cores with the magnet between the pair of cores, the pair of cores being horizontally disposed and each core of the pair of cores having an end facing a lateral surface of the magnet.

In one such embodiment, the first rod and the second rod have the same length.

In a further embodiment, the magnet is interposed between a first core and a second core, where one lateral surface of the magnet facing the first core has a polarity opposite to that of the other lateral surface of the magnet facing the second core.

According to an embodiment, the shutter blade is formed with a hinge hole hinged to a base at one end thereof, a shutter plate for opening/shutting a light permeation hole of the base at the other end thereof, and a slot into which a driving shaft formed at the slider is inserted.

In another general aspect of the present disclosure, there is provided an optical apparatus, the apparatus comprising: a camera including a display unit arranged at a front surface of a main body for displaying information, and a camera shutter device provided at the main body, wherein the camera shutter device includes: a core wrapped by a coil, wherein a first distal end of the core and a second distal end of the core are arranged in parallel at one end of the core and each of the two distal ends exhibits a mutually opposite polarity when a voltage is applied to the coil; a magnet arranged with a lateral surface facing the two distal ends for linearly and reciprocally moving between the first and second distal ends; and a slider for opening/shutting a shutter blade as the magnet linearly and reciprocally moves.

According to an embodiment of the optical apparatus, the core includes a fixture fixed at a base; a first rod extended from the fixture, wrapped by a coil, and generating a first electromagnetic force line, where the first rod provides the first distal end; and a second rod extended from the fixture, arranged in parallel with the first rod, and generating a second electromagnetic force line, where the second rod provides the second distal end.

In one embodiment, the core constitutes a pair of cores with the magnet between the pair of cores, each core of the pair having an end facing a lateral surface of the magnet and extending at a predetermined angle from the magnet.

In a further embodiment, each core of the pair of cores is wrapped with a corresponding coil of a pair of coils and the pair of coils is applied with a mutually opposite direction of voltage.

In accordance with certain embodiments of the invention, the first and second distal ends are aligned at an angle to face a lateral surface of the magnet.

According to one embodiment, the first rod having the first distal end is shorter than the second rod having the second distal end.

According to another embodiment, the core constitutes a pair of cores so arranged as to face the two lateral surfaces of the magnet at opposite sides of the magnet while being horizontally arranged.

In one such embodiment, the first rod and the second rod have the same length.

In a further embodiment, the magnet is interposed between a first core and a second core, where one lateral surface of the magnet facing the first core has a polarity opposite to that of the other lateral surface of the magnet facing the second core.

According to an embodiment, the shutter blade is formed with a hinge hole hinged to a base at one end thereof, a shutter plate for opening/shutting a light permeation hole of the base at the other end thereof, and a slot into which a driving shaft formed at the slider is inserted.

### ADVANTAGEOUS EFFECTS

The camera shutter device according to the present disclosure has an advantageous effect in that a magnet linearly and reciprocally moves between a first distal end and a second distal end of a core to activate a shutter blade, whereby miniaturization and thinning of the shutter device can be realized.

The camera shutter device according to the present disclosure has another advantageous effect in that a reciprocating distance of the magnet can be minimized to increase an opening/shutting speed, whereby performance of a camera can be improved.

### BRIEF DESCRIPTION OF THE DRAWINGS

The accompanying drawings, which arc included to provide a further understanding of the disclosure and are incorporated in and constitute a part of this application, illustrate embodiment(s) of the disclosure and together with the description serve to explain the principle of the disclosure. In the drawings:

FIG. 1 is a perspective view illustrating an optical apparatus according to an exemplary embodiment of the present disclosure;

FIG. 2 is a structural view illustrating a camera shutter device according to an exemplary embodiment of the present disclosure;

FIG. 3 is a perspective view illustrating a driving unit of a camera shutter device according to an exemplary embodiment of the present disclosure;

FIG. 4 is a perspective view illustrating a driving unit of a camera shutter device according to a second exemplary embodiment of the present disclosure; and

FIGS. 5 and 6 are operation status views illustrating a camera shutter device according to an exemplary embodiment of the present disclosure.

### DETAILED DESCRIPTION

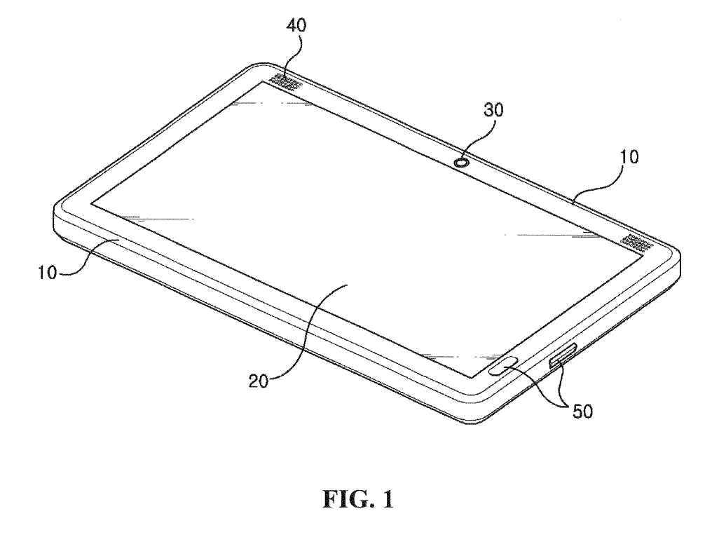

The disclosed embodiments and advantages thereof are best understood by referring to FIGS. 1-6 of the drawings, like numerals being used for like and corresponding parts of the various drawings. Other features and advantages of the disclosed embodiments will be or will become apparent to one of ordinary skill in the art upon examination of the following figures and

### DETAILED DESCRIPTION

The exemplary embodiments described here in detail for illustrative purposes are subject to many variations in structure and design. It should be emphasized, however, that the present disclosure is not limited to a particular disclosure, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like herein do not denote any order, quantity, or importance, but rather are used to distinguish one element from another, and the terms “a” and “an” herein do not denote a limitation of quantity, but rather denote the presence of at least one of the referenced item.

In describing embodiments of the present invention, detailed descriptions of constructions or processes known in the art may be omitted to avoid obscuring appreciation of the invention by a person of ordinary skill in the art with unnecessary detail regarding such known constructions and functions. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

The limitations in the claims are to be interpreted broadly based the language employed in the claims and not limited to examples described in the present description or during the prosecution of the application, which examples are to be construed as non-exclusive. For example, in the present disclosure, the term “preferably”, “preferred” or the like is non-exclusive and means “preferably”, but not limited to.

It will be understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”. Furthermore, “exemplary” is merely meant to mean an example, rather than the best.

FIG. 1 is a perspective view illustrating an optical apparatus according to an exemplary embodiment of the present disclosure.

The optical apparatus according to an exemplary embodiment of the present disclosure includes a main body (10), a display unit (20) arranged at a front surface of the main body (10) for displaying visual information or image information, a camera (30) mounted at one side of the main body (10) to capture an image or a photograph, a speaker (40) for outputting a sound, and an input unit (50) by which a user can input information.

The optical apparatus may be applied to any electronic apparatus mounted with a camera including, but not limited to, a laptop computer, a tablet PC, a mobile phone, a smart phone, a distal broadcasting terminal, a PDA (Personal Digital Assistant), a PMP (Portable Multimedia Player) and a navigation device. In accordance with embodiments of the invention, the camera (30) is mounted with a camera shutter device for opening/shutting a lens nozzle.

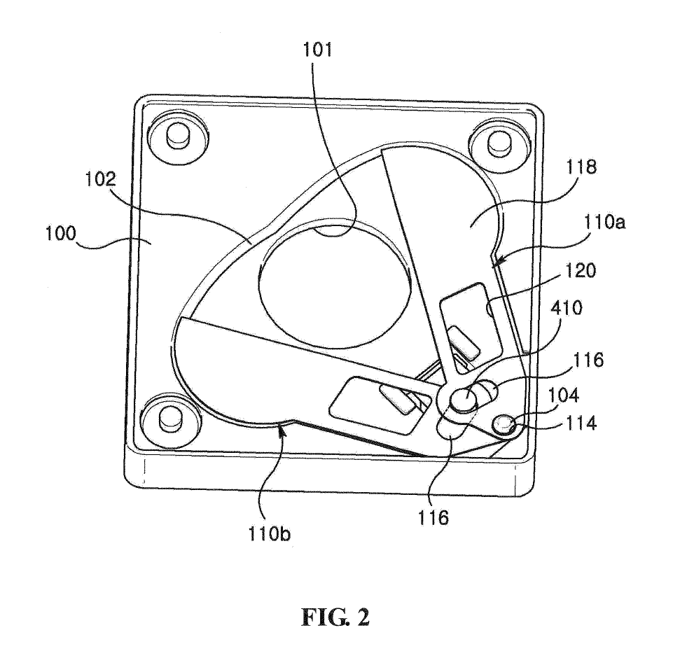

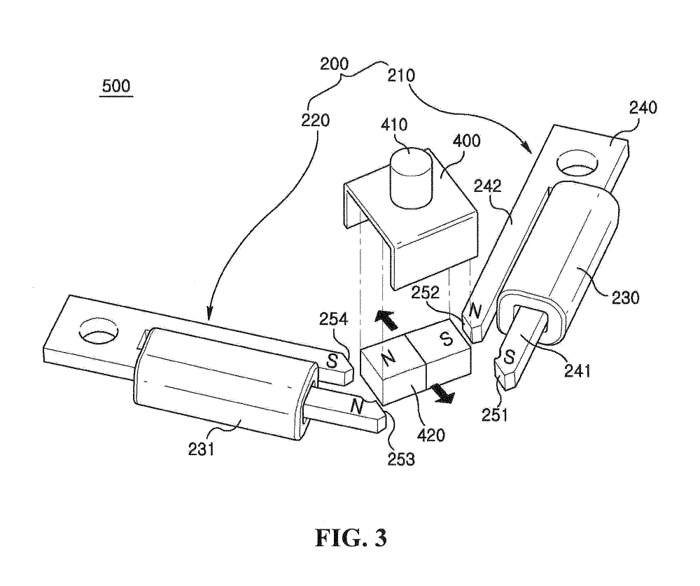

FIG. 2 is a structural view illustrating a camera shutter device according to an exemplary embodiment of the present disclosure, and FIG. 3 is a perspective view illustrating a driving unit of a camera shutter device according to an exemplary embodiment of the present disclosure.

Referring to FIGS. 2 and 3, a configuration of a camera shutter device according to the present disclosure will be described in detail.

A shutter device according to an exemplary embodiment of the present disclosure includes a base (100) formed with a light permeation hole (101), a pair of shutter blades (110a, 110b) rotatably formed at the base for opening/shutting the light permeation hole (101), and a driving unit (500) for driving the pair of shutter blades (110a, 110b).

The base (100) is mounted on an optical image device, and can be centrally formed with the light permeation hole (101) and formed with an accommodation unit (102) in which the pair of shutter blades (110a, 110b) is rotatably accommodated. The base (100) is formed at one side thereof with a hinge axis (104) on which the pair of shutter blades (110a, 110b) is hinged in an overlapped state.

The shutter blades (110a, 110b) are formed in a pair to cover (i.e., shut) the light permeation hole (101) by rotating to a mutually-wrapping direction, and to open the light permeation hole (101) by rotating to a mutually-separating direction.

The shutter blades (110a, 110b) are formed at one side thereof with a hinge hole (114) rotatably supported by the hinge axis (104), and are formed at the other side thereof with a semi-circular shutter plate (118) to open/shut the light permeation hole (101). The shutter blades (110a, 110b) are also formed with a slot (116) that rotates the shutter plate (118) when a driving shaft (410) of the driving unit (500) is inserted to linearly and reciprocally move the driving axis (410). The shutter blades (110a, 110b) are further formed with a stopper hole (120) hinged by a stopper formed at the base (100) to restrict a rotation scope.

The slot (116) is formed at a place near the hinge hole (114) to minimize the linear reciprocating stroke of the driving axis (410), whereby the shutter blades (110a, 110b) can quickly perform the opening/shutting operation. Furthermore, the shutter blades (110a, 110b) can minimize the length of the slot (116) due to opening/shutting operation through linear reciprocating operation of the driving axis (410).

Referring to FIG. 3, the driving unit (500) includes a core (200), a coil (230) wrapped on the core (200) to magnetize the core (200) when a power is applied, a magnet (420) arranged in opposition to the core (200) such that the magnet linearly moves when the core (200) is magnetized, and a slider (400) fixed at the magnet (420) and formed with a driving axis (410).

The core (200) includes a fixture (240) fixed at the base (100), a first rod (241) extended from the fixture (240) and wrapped by the coil (230), and a second rod (242) extended from the fixture (240) and arranged in parallel with the first rod (241) at a predetermined distance.

At this time, the coil (230) may be wrapped on the first rod (241), the second rod (242), or the fixture (240).

A first distal end (251) generating an electromagnetic force line of the first rod (241) and a second distal end (252) generating an electromagnetic force line of the second rod (242) are arranged in parallel. The two distal ends exhibit a mutually opposite polarity with respect to each other.

For example, if a voltage of forward direction is applied to the coil, the first distal end (251) is magnetized with S polarity, while the second distal end (252) is magnetized with N polarity. Alternatively, if a voltage of reverse direction is applied to the coil, the first distal end (251) is magnetized with N polarity, while the second distal end (252) is magnetized with S polarity.

The first and second distal ends (251, 252) are aligned at an angle to face a lateral surface of the magnet. Each end can have a same gap distance to the lateral surface of the magnet. That is, the first and second distal ends (251, 252) are aligned at an angle to face a lateral surface of the magnet because the core (200) is arranged at a predetermined angle relative to the magnet (420).

Furthermore, the outwardly-formed first rod (241) is longer than the inwardly-formed second rod (242), such that a gap formed between the first distal end (251) and the magnet (420), and a gap formed between the second distal end (252) and the magnet (420) are the same.

The core constitutes a pair of cores about the magnet (420). That is, the core (200) includes a first core (210) formed at one side of the magnet (420) and a second core (220) formed at the other side of the magnet (420), such that the distal ends (251,252) of the first core (210) and the distal ends (253,254) of the second core (220) arc so arranged as to face each other.

A coil (230) wrapped on the first core (210) and a coil (231) wrapped on the second core (220) are applied with mutually opposite voltages. That is, if a voltage of forward direction is applied to the coil (230) of the first core (210), the coil (231) of the second core (220) is magnetized with a voltage of an opposite direction. Therefore, the first core (210) and the second core (220) are always oppositely magnetized.

For example, if the first distal end (251) of the first core (210) is magnetized with S polarity, a first distal end (253) of the second core (220) is magnetized with N polarity, and if the second distal end (252) of the first core (210) is magnetized with N polarity, a second distal end (254) of the second core (220) is magnetized with S polarity.

The magnet (420) is so arranged as to allow one lateral surface facing the first core (210) to have an opposite polarity from the other lateral surface facing the second core (220). For example, if the one lateral surface of the magnet (420) is magnetized with S polarity, the other lateral surface of the magnet (420) is magnetized with N polarity.

The slider (400), on which the driving axis (410) is formed, is fixed at an upper surface of the magnet (420).

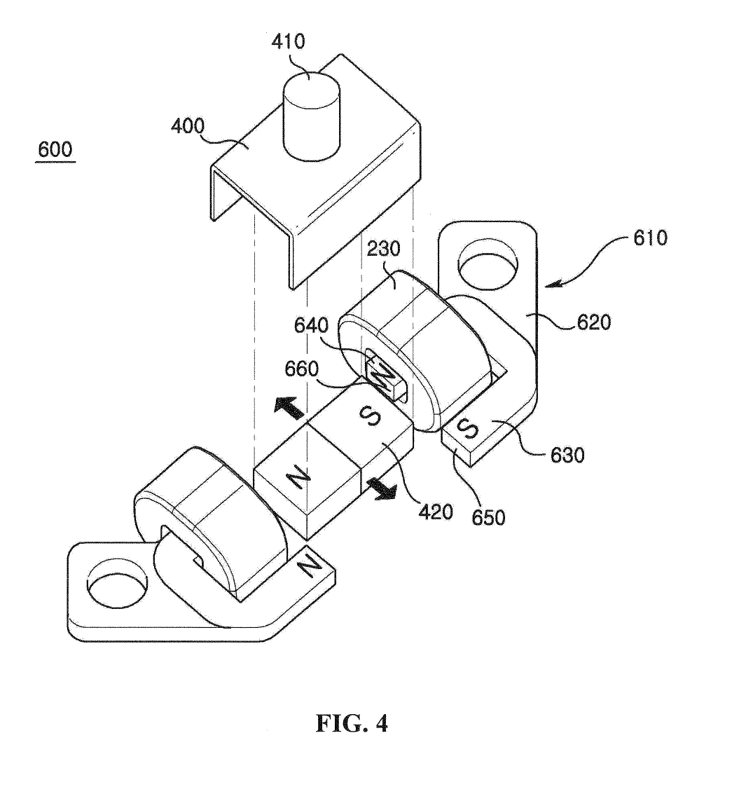

FIG. 4 is a perspective view illustrating a driving unit of a camera shutter device according to a second exemplary embodiment of the present disclosure.

A driving unit (600) according to the second exemplary embodiment of the present disclosure is constructed with a similar configuration as that of the driving unit (500), except that its core (610) is differently structured from the core (200) according to the first exemplary embodiment of the present disclosure.

That is, the core (610) includes a fixture (620) fixed at the base (100), a first rod (630) extended from the fixture (620), and a second rod (640) that is arranged in parallel with the first rod (630). At this time, the core (610) and the magnet (420) are horizontally arranged. That is, the first and second rods (630, 640) are horizontally arranged with the magnet (420), and the fixture (620) is angled to cater to the shape of the base (100).

Furthermore, each of the first and second rods (630, 640) have a same length, and a first distal end (650) of the first rod (630) and a second distal end (660) of the second rod (640) are arranged in opposition to the magnet (420). The coil (230) can be wrapped on the first rod (630) or the second rod (640).

Now, operation of the camera shutter device according to an exemplary embodiment of the present disclosure will be described in the following manner.

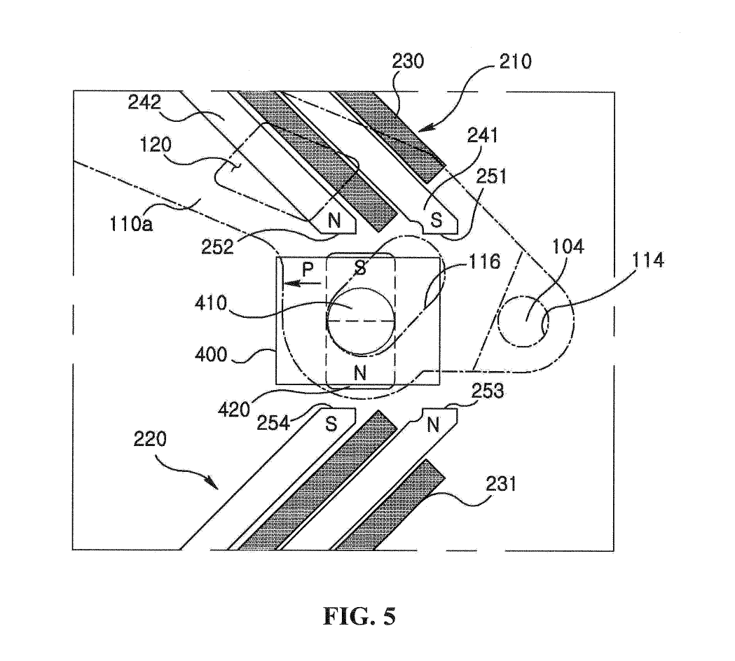

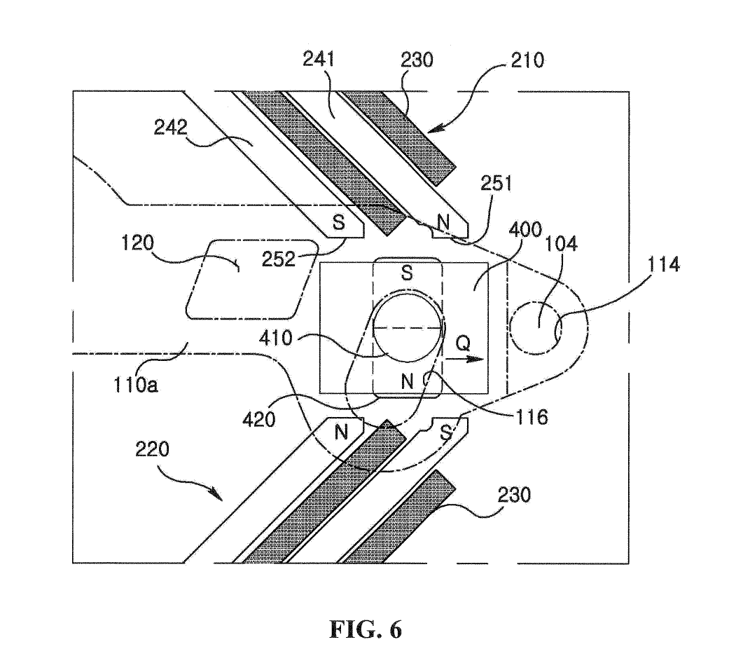

FIG. 5 is an operation status view illustrating a shutter blade being opened according to an exemplary embodiment of the present disclosure, and FIG. 6 is an operation status view illustrating a shutter blade being shut according to an exemplary embodiment of the present disclosure.

Firstly, description will be made to a process of the shutter blades (110a, 110b) being opened.

When a voltage of forward direction is applied to the coil (230) of the first core (210), and a voltage of reverse direction is applied to the coil (231) of the second core (220), the first distal end (251) of the first core (210) is magnetized with S polarity, and the second distal end (252) of the first core (210) is magnetized with N polarity. In addition, the first distal end (253) of the second core (220) is magnetized with N polarity, and the second distal end (254) of the second core (220) is magnetized with S polarity. Accordingly, a repulsive force is applied between the first distal ends (251, 253) of the core and the magnet (420) due to the fact that the lateral surface of the magnet (420) facing the first core (210) is magnetized with S polarity and the lateral surface of the magnet (420) facing the second core (220) is magnetized with N polarity. In addition, an attractive force applied between the second distal ends (252, 254) and the magnet (420) due to the polarities of the elements moves the magnet (420) in the direction indicated by the arrow P. As a result, the driving axis (410) advances to move along the slot (116) and to operate in a direction of opening the shutter blades (110a, 110b).

Secondly, description will be made to a process of the shutter blades (110a, 110b) being shut.

When a voltage of reverse direction is applied to the coil (230) of the first core (210), and a voltage of forward direction is applied to the coil (231) of the second core (220), the first distal end (251) of the first core (210) is magnetized with N polarity, and the second distal end (252) is magnetized with S polarity. In addition, the first distal end (253) of the second core (220) is magnetized with S polarity, and the second distal end (254) of the second core (220) is magnetized with N polarity. Accordingly, an attractive force is applied between the magnet (420) and the first distal ends (251, 253) of the core, and a repulsive force is applied between the magnet (420) and the second distal ends (252, 254) of the core to move the magnet (420) in the direction indicated by the arrow Q. As a result, the driving axis (410) retracts to move along the slot (116) and to operate in a direction of shutting the shutter blades (110a, 110b).

As apparent from the foregoing, the camera shutter device according to the present disclosure has an industrial applicability in that a magnet linearly reciprocally moves between first and second distal ends of a core to generate a driving force, whereby the driving unit can be miniaturized and thinned.

The camera shutter device according to the present disclosure has another industrial applicability in that a reciprocatively moving distance of a magnet can be minimally shortened to quicken the opening/shutting operation.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

What is claimed is:

1. A camera shutter device, the device comprising:
a core wrapped by a coil, wherein a first distal end of the core and a second distal end of the core arc arranged in parallel at a same end of the core, and when a voltage is applied to the coil, the first distal end and the second distal end exhibit a mutually opposite polarity;
a magnet having a lateral side exhibiting a particular polarity arranged to face the first and second distal ends for linearly and reciprocally moving between the first and second distal ends; and
a slider for opening/shutting a shutter blade as the magnet linearly and reciprocally moves.

2. The device of claim 1, wherein the core comprises:
a fixture for fixing the core at a base;
a first rod extended from the fixture, wrapped by a coil and generating a first electromagnetic force line, wherein the first rod provides the first distal end; and
a second rod extended from the fixture, arranged in parallel with the first rod and generating a second electromagnetic force line, wherein the second rod provides the second distal end.

3. The device of claim 2, wherein the core is a pair of cores with the magnet between the pair of cores,
wherein each core of the pair of cores has an end with first and second distal ends facing the magnet,
wherein each core of the pair of cores is arranged extending at an angle from the magnet.

4. The device of claim 3, wherein each core of the pair of cores is wrapped with a corresponding one of a pair of coils, wherein the pair of coils are configured to be applied with a mutually opposite direction of voltage.

5. The device of claim 3, wherein the first and second distal ends of a first core of the pair of cores facing a first lateral surface of the magnet are angled to align with the first lateral surface of the magnet, and the first and second distal ends of a second core of the pair of cores facing a second lateral surface of the magnet opposite the first lateral surface of the magnet are angled to align with the second lateral surface of the magnet.

6. The device of claim 3, wherein the first rod is shorter than the second rod.

7. The device of claim 2, wherein the core is a pair of horizontally aligned cores so arranged as to face the opposite lateral surfaces of the magnet.

8. The device of claim 7, wherein the first rod and the second rod have a same length.

9. The device of claim 1, wherein the core comprises a first core wrapped with a first coil and a second core wrapped with a second coil, wherein the magnet is interposed between the first core and the second core, wherein the lateral side facing the first core has a polarity opposite to that of the lateral side facing the second core.

10. The device of claim 1, wherein the shutter blade has a hinge hole at one end thereof for hinging to a base, a shutter plate at an opposite end thereof for opening/shutting a light permeation hole of the base, and a slot into which a driving shaft formed at the slider is inserted.

11. An optical apparatus, the apparatus comprising:
a camera including a display unit arranged at a front surface of a main body for displaying information, and a camera shutter device provided at the main body,
wherein the camera shutter device includes:
a core wrapped by a coil, wherein a first distal end of the core and a second distal end of the core are arranged in parallel at a same end of the core, and when a voltage is applied to the coil, the first distal end and the second distal end exhibit a mutually opposite polarity;
a magnet having a lateral side exhibiting a particular polarity arranged to face the first and second distal ends for linearly and reciprocally moving between the first and second distal ends; and
a slider for opening/shutting a shutter blade as the magnet linearly and reciprocally moves.

12. The apparatus of claim 11, wherein the core comprises:
a fixture for fixing the core at a base;
a first rod extended from the fixture, wrapped by a coil and generating a first electromagnetic force line, wherein the first rod provides the first distal end; and
a second rod extended from the fixture, arranged in parallel with the first rod and generating a second electromagnetic force line, wherein the second rod provides the second distal end.

13. The apparatus of claim 12, wherein the core is a pair of cores with the magnet between the pair of cores,
wherein each core of the pair of cores has an end with first and second distal ends facing the magnet,
wherein each core of the pair of cores is arranged extending at an angle from the magnet.

14. The apparatus of claim 13, wherein each core of the pair of cores is wrapped with a corresponding one of a pair of coils, wherein the pair of coils arc configured to be applied with a mutually opposite direction of voltage.

15. The apparatus of claim 13, wherein the first and second distal ends of a first core of the pair of cores facing a first lateral surface of the magnet are angled to align with the first lateral surface of the magnet, and the first and second distal ends of a second core of the pair of cores facing a second lateral surface of the magnet opposite the first lateral surface of the magnet are angled to align with the second lateral surface of the magnet.

16. The apparatus of claim 13, wherein the first rod is shorter than the second rod.

17. The apparatus of claim 12, wherein the core is a pair of horizontally aligned cores so arranged as to face opposite lateral surfaces of the magnet.

18. The apparatus of claim 17, wherein the first rod and the second rod have a same length.

19. The apparatus of claim 11, wherein the core comprises a first core wrapped with a first coil and a second core wrapped with a second coil, wherein the magnet is interposed between the first core and the second core, wherein the lateral side facing the first core has a polarity opposite to that of the lateral side facing the second core.

20. The apparatus of claim 11, wherein the shutter blade has a hinge hole at one end thereof for hinging to a base, a shutter plate at an opposite end thereof for opening/shutting a light permeation hole of the base, and a slot into which a driving shaft formed at the slider is inserted.
